(19) United States
(12) Patent Application Publication
(10) Pub. No.: US 2004/0135371 A1
(43) Pub. Date: Jul. 15, 2004

(54) Fuel pipe joint with excellent fuel permeation resistance

(75) Inventors: Haruhisa Masuda, Osaka (JP); Yuji Munesawa, Tsukuba-shi (JP); Koichi Warino, Tsukuba-shi (JP); Noriyuki Isobe, Ube-shi (JP); Hideki Fujimura, Ube-shi (JP); Yoshiro Iwata, Ube-shi (JP); Koji Nakamura, Ube-shi (JP); Kozo Tamura, Pasadena, TX (US)

Correspondence Address: IP DEPARTMENT OF PIPER RUDNICK LLP, ONE LIBERTY PLACE, SUITE 4900, 1650 MARKET ST, PHILADELPHIA, PA, 19103, US

(73) Assignees: Kuraray Co., Ltd., a Japanese corporation, Kurashiki-shi (JP); Ube Industries, Ltd., a Japanese corporation, Ube-shi (JP)

(21) Appl. No.: 10/685,265

(22) Filed: Oct. 14, 2003

(30) Foreign Application Priority Data
Oct. 29, 2002 (JP) 2002-315020

(51) Int. Cl. F16L 37/00

(52) U.S. Cl. 285/423; 285/305

(57) ABSTRACT

A fuel pipe joint having excellent fuel permeation resistance, particularly a fuel pipe joint for use in automobiles, which can greatly reduce the amount of fuel permeated through the wall and exhibits excellent rigidity and fuel barrier property even at high temperatures, the fuel pipe joint using a joint material comprising a polyamide (nylon 9T) consisting of a dicarboxylic acid component and a diamine component, with 60 to 100 mol % of the dicarboxylic acid component being a terephthalic acid and 60 to 100 mol % of the diamine component being a diamine component selected from 1,9-nonanediamine and 2-methyl-1,8-octanediamine. The joint material preferably further comprises a reinforcement and/or an electrically conducting filler. The electrically conducting filler preferably has an aspect ratio of 50 or more and a short diameter of 0.5 nm to 10 μm.

### BACKGROUND OF THE INVENTION

1. Field of the Invention

The present invention relates to a fuel pipe joint in which the amount of fuel permeating through the wall is reduced and which has excellent rigidity and fuel barrier properties even at high temperatures. More specifically, the present invention relates to a fuel-pipe quick-connector used in automobiles.

2. Description of Related Art

Conventionally, a combination of a metal tube and a rubber tube has been used for the fuel pipe of automobiles. However, the rubber tube is insufficient in the barrier property against gasoline or the like used as a fuel for automobiles and not preferred in view of safety and the environment. In addition, the rubber tube is heavy and moreover, in connecting it with a metal tube, its handleability is bad. Because, for example, the rubber tube must be externally fitted to the end part of the metal tube and further fixed by clamping the outer periphery with a hose band.

Therefore, a resin tube has recently been used in place of the rubber tube. The resin tube has excellent barrier property against gasoline and is lightweight compared with a rubber tube. Furthermore, a connector capable of quickly joining a resin tube and a metal tube has been developed in the United States of America and has come to be used as a system excellent in handleability. This connector is also called a quick-connector, and this is a female-type quick connector of a plastic housing removably engaged with the end part of a metal or plastic male-type tube (see, for example, U.S. patent application Publication Ser. No. 2000-0046111). The end part of male-type tube opposed to the female-type housing has a plurality of axially parted barbs formed on the outer peripheral surface and the system is joined by a polyamide resin or plastic tube press-fitted to cover the barbs.

In addition, U.S. Federal Law requires a great reduction in the diffusion of hydrocarbons in automobile fuel and the fuel-tube including the join part is required to have a high permeation-inhibiting performance.

Of resin-made tubes, tubes made of nylon 11 resin or nylon 12 resin have been used because of their excellent mechanical properties and resistance against chemicals, however, these cannot provide the required hydrocarbon permeation-inhibiting performance. To cope with this, a multilayer tube where a resin having good barrier property against fuel, for example, EVOH (ethylene-vinyl alcohol copolymer), PBT or fluororesin, is disposed as a barrier layer has been proposed (see, for example, International Application Publication No. WO93/25835).

By using a tube having such a high barrier performance, the permeation through the pipe can be reduced to far below the envisaged upper limit of hydrocarbon diffusion. In the quick connector, the nylon 12 or nylon 66 resin is widely used, however, with the permeation inhibiting performance of the material itself, it will be probably required to reduce the diffusion amount by increasing the wall thickness of the quick connector or reducing the number of connectors disposed so as to cope with strict regulations in future. Furthermore, due the global warming, the air temperature will be substantially elevated and the amount of fuel permeated is liable to increase.

In order to satisfy such a requirement for the prevention of hydrocarbon from permeation, a technique of improving the sealing property by disposing an O-ring or performing spin welding has been proposed (see, for example, Japanese Unexamined Patent Publication (Kokai) Nos. 2000-310381 and 2001-263570). However, due to permeation from the cylindrical base material of the quick connector, the future design may be restricted.

An object of the present invention is to solve these problems, that is, to provide a fuel pipe joint, particularly a fuel pipe joint for use in automobiles, in which the amount of fuel permeating through the wall can be greatly reduced and exhibits excellent rigidity and fuel barrier properties even at high temperatures.

### SUMMARY OF THE INVENTION

More specifically, the present invention relates to the following:

[1] A fuel pipe joint having excellent fuel permeation resistance, using a joint material comprising a polyamide (nylon 9T) consisting of a dicarboxylic acid component and a diamine component, with 60 to 100 mol % of the dicarboxylic acid component being a terephthalic acid and 60 to 100 mol % of the diamine component being a diamine component selected from 1,9-nonanediamine and 2-methyl-1,8-octanediamine.

[2] A fuel pipe joint, having excellent fuel permeation resistance, using a joint material comprising a polyamide resin composition comprising from 50 to 99 parts by weight of a polyamide (nylon 9T) and from 1 to 50 parts by weight of another polyamide resin and/or another thermoplastic resin, said polyamide (nylon 9T) consisting of a dicarboxylic acid component and a diamine component, with 60 to 100 mol % of the dicarboxylic acid component being terephthalic acid and 60 to 100 mol % of the diamine component being a diamine component selected from 1,9-nonanediamine and 2-methyl-1,8-octanediamine.

[3] The fuel pipe joint as set forth in [1] or [2], wherein the joint material further comprises a reinforcement.

[4] The fuel pipe joint as set forth in [1] or [2], wherein the joint material further comprises an electrically conducting filler.

[5] The fuel pipe joint as set forth in [4], wherein the electrically conducting filler has an aspect ratio of 50 or more and a short diameter of 0.5 nm to 10

[6] The fuel pipe joint as set forth in [1] or [2], wherein the joint material further comprises a reinforcement and an electrically conducting filler at a ratio of 1:3 to 3:1 by weight.

[7] A fuel pipe quick-connector comprising a cylindrical body formed of the joint material as set forth in [1] or [2].

[8] The fuel pipe quick connector comprising a cylindrical body formed of the joint material as set forth in [3].

[9] The fuel pipe quick connector comprising a cylindrical body formed of the joint material as set forth in [4].

[10] The fuel pipe quick connector comprising a cylindrical body formed of the joint material as set forth in [5].

[11] The fuel pipe quick connector comprising a cylindrical body formed of the joint material as set forth in [6].

[12] The fuel pipe quick connector as set forth in [7], comprising a joint body having a first and second end portions, from said first and second end portions of the joint body a continuous hollow portion being formed, said first end portion of said joint body being able to liquid-tightly engage with a resin first tube, said second end portion of said joint body being able to liquid-tightly engage with a male-type second tube, wherein said joint body is made of said joint material.

[13] The fuel pipe quick connector as set forth in [12], wherein said first end portion of said joint body is formed as a nipple.

[14] The fuel pipe quick connector as set forth in [13], further comprising an O-ring around said nipple of said first end portion of said joint body for liquid-tightly connecting said resin first tube.

[15] The fuel pipe quick connector as set forth in [14], wherein said nipple of said first end portion of said joint body has a plurality of protruded barbs on an outer peripheral surface thereof.

[16] The fuel pipe quick connector as set forth in [12], further comprising an O-ring around said hollow portion at said second end portion of said joint body in order to liquid-tightly engage with said male-type second tube.

[17] The fuel pipe quick connector as set forth in [12], wherein said second tube is a metal (stainless steel) or resin tube.

[18] The fuel pipe quick connector as set forth in [12], wherein said second tube has a flange portion and said fuel pipe quick connector further comprises a retainer inside said fuel joint body at said second end portion thereof for engaging with and retaining the flange portion of said second tube.

[19] The fuel pipe quick connector as set forth in [18], wherein said retainer is made of said joint material.

[20] A fuel pipe component obtained by joining the quick connector as set forth in [7] with a polyamide resin tube by a welding method selected from spin welding, vibration welding, laser welding and ultrasonic welding.

[21] The fuel pipe component as set forth in [20], wherein the polyamide resin tube is a multilayer tube comprising a barrier layer.

### BRIEF DESCRIPTION OF THE DRAWING

FIG. 1 shows a cross-sectional view of a representative quick connector.

### DETAILED DESCRIPTION OF THE INVENTION

The present invention is described in detail below.

In the present invention, the polyamide used for the joint material is a polyamide consisting of a dicarboxylic acid component with 60 to 100 mol % of the dicarboxylic acid component being a terephthalic acid, and a diamine component with 60 to 100 mol % of the diamine component being a diamine component selected from 1,9-nonanediamine and 2-methyl-1,8-octanediamine (this polyamide is hereinafter sometimes simply referred to as “nylon 9T”).

As the dicarboxylic acid component of nylon 9T, a terephthalic acid is used. The amount of the terephthalic acid used is 60 mol % or more, preferably 75 mol % or more, more preferably 90 mol % or more, based on the entire amount of the dicarboxylic acid component. If the terephthalic acid content is less than 60 mol %, the obtained polyamide disadvantageously decreases in various physical properties such as heat resistance and chemical resistance. Examples of the dicarboxylic acid other than the terephthalic acid include aliphatic dicarboxylic acids such as malonic acid, dimethylmalonic acid, succinic acid, glutaric acid, adipic acid, 2-methyladipic acid, trimethyladipic acid, pimelic acid, 2,2-dimethylglutaric acid, 3,3-diethylsuccinic acid, azelaic acid, sebacic acid and suberic acid; alicyclic dicarboxylic acids such as 1,3-cyclopentanedicarboxylic acid and 1,4-cyclohexanedicarboxylic acid; aromatic dicarboxylic acids such as isophthalic acid, 2,6-naphthalenedicarboxylic acid, 2,7-naphthalenedicarboxylic acid, 1,4-naphthalenedicarboxylic acid, 1,4-phenylenedioxydiacetic acid, 1,3-phenylenedioxydiacetic acid, diphenic acid, 4,4′-oxydibenzoic acid, diphenylmethane-4,4′-dicarboxylic acid, diphenylsulfone-4,4′-dicarboxylic acid and 4,4′-biphenyldicarboxylic acid; and an arbitrary mixture thereof. Among these, aromatic dicarboxylic acids are preferred. In addition, a polyvalent carboxylic acid such as trimellitic acid, trimesic acid and pyromellitic acid may also be used in the range of not inhibiting the moldability.

As the diamine component of nylon 9T, a diamine selected from 1,9-nonanediamine and 2-methyl-1,8-octanediamine is used. The amount of the diamine used is 60 mol % or more, preferably 70 mol % or more, more preferably 80 mol % or more, based on the entire amount of the diamine component. When a diamine selected from 1,9-nonanediamine and 2-methyl-1,8-octanediamine is used as the diamine component in the above-described amount, a polyamide resin excellent in all of heat resistance, moldability, chemical resistance, low water absorption, lightweightness, dynamic properties and mold-processability is obtained.

The molar ratio of 1,9-nonanediamine and 2-methyl-1,8-octanediamine is preferably from 50:50 to 95:5, more preferably from 60:40 to 90:10.

Examples of the diamine component other than those diamines include aliphatic diamines such as ethylenediamine, propylenediamine, 1,4-butanediamine, 1,6-hexanediamine, 1,8-octanediamine, 1,10-decanediamine, 1,12-dodecanediamine, 3-methyl-1,5-pentanediamine, 2,2,4-trimethyl-1,6-hexanediamine, 2,4,4-trimethyl-1,6-hexanediamine and 5-methyl-1,9-nonanediamine; alicyclic diamines such as cyclohexanediamine, methylcyclohexanediamine and isophoronediamine; aromatic diamines such as p-phenylenediamine, m-phenylenediamine, xylenediamine, 4,4′-diaminodiphenylmethane, 4,4′-diaminodiphenylsulfone, 4,4′-diaminodiphenyl ether; and an arbitrary mixture thereof.

In the nylon 9T, the terminal of its molecular chain is preferably blocked by a terminal-blocking agent. The terminal-blocking agent preferably blocks 40% or more, more preferably 60% or more, still more preferably 70% or more, of the terminal groups.

The terminal-blocking agent is not particularly limited as long as it is a monofunctional compound having reactivity with an amino or carboxyl group at the terminal of polyamide. In view of reactivity and stability of the blocked terminal, monocarboxylic acids and monoamines are preferred, and in view of easy handleability, monocarboxylic acids are more preferred. In addition, acid anhydrides, monoisocyanates, monoacid halides, monoesters and monoalcohols may also be used.

The monocarboxylic acid used as the terminal-blocking agent is not particularly limited as long as it has reactivity with an amino group, but examples thereof include aliphatic monocarboxylic acids such as acetic acid, propionic acid, butyric acid, valeric acid, caproic acid, capric acid, lauric acid, tridecylic acid, myristic acid, palmitic acid, stearic acid, pivalic acid and isobutyric acid; alicyclic monocarboxylic acids such as cyclohexanecarboxylic acid; aromatic monocarboxylic acids such as benzoic acid, toluic acid, α-naphthalenecarboxylic acid, β-naphthalenecarboxylic acid, methylnaphthalenecarboxylic acid and phenylacetic acid; and an arbitrary mixture thereof. Among these, in view of the reactivity, stability of the blocked terminal and cost, acetic acid, propionic acid, butyric acid, valeric acid, caproic acid, capric acid, lauric acid, tridecylic acid, myristic acid, palmitic acid, stearic acid and benzoic acid are preferred.

The monoamine used as the terminal-blocking agent is not particularly limited as long as it has reactivity with a carboxyl group, but examples thereof include aliphatic monoamines such as methylamine, ethylamine, propylamine, butylamine, hexylamine, octylamine, decylamine, stearylamine, dimethylamine, diethylamine, dipropylamine and dibutylamine; alicyclic monoamines such as cyclohexylamine and dicyclohexylamine; aromatic amines such as aniline, toluidine, diphenylamine and naphthylamine; and an arbitrary mixture thereof. Among these, in view of the reactivity, boiling point, stability of the blocked terminal and cost, butylamine, hexylamine, octylamine, decylamine, stearylamine, cyclohexylamine and aniline are preferred.

The amount of the terminal-blocking agent used for the production of nylon 9T is determined by the intrinsic viscosity [η] of the finally obtained polyamide and the percentage of the terminal group blocked. Specifically, the amount used is usually from 0.5 to 10 mol % based on the total molar number of dicarboxylic acid component and diamine component, though this varies depending on the reactivity and boiling point of the terminal-blocking agent used, reaction apparatus, reaction conditions and the like.

The nylon 9T for use in the present invention preferably has a intrinsic viscosity [η] as measured at 30° C. in concentrated sulfuric acid, of 0.4 to 3.0 dl/g, more preferably from 0.6 to 2.0 dl/g, still more preferably from 0.8 to 1.6 dl/g.

The polyamide for use in the joint material constituting the fuel pipe joint of the present invention may be a nylon 9T alone or may be a mixture of a nylon 9T and another polyamide resin or another thermoplastic resin. In the mixture, the nylon 9T content is preferably 50 wt % or more.

Examples of the another polyamide resin include polyethyleneadipamide (nylon 26), polytetramethyleneadipamide (nylon 46), polyhexamethyleneadipamide (nylon 66), polyhexamethyleneazelamide (nylon 69), polyhexamethylenesebacamide (nylon 610), polyhexamethyleneundecamide (nylon 611), polyhexamethylenedodecamide (nylon 612), polycapramide (nylon 6), polyundecanamide (nylon 11), polydodecanamide (nylon 12), polyhexamethyleneterephthalamide (nylon 6T), polyhexamethyleneisophthalamide (nylon 6I), polynonamethylenedodecamide (nylon 912), polydodecamethylenedodecamide (nylon 1212), polymethaxylyleneadipamide (nylon MXD6), polytrimethylhexamethyleneterephthalamide nylon (TMHT), polybis(4-aminocyclohexyl)methanedodecamide (nylon PACM12), polybis(3-methyl-4-aminocyclohexyl)methanedodecamide (nylon dimethyl PACM12), polyundecamethyleneterephthalamide (nylon 11T) and copolymers thereof.

In particular, nylon 6, nylon 11, nylon 12, nylon 610, nylon 612 and copolymers thereof are suitably used for the improvement of moldability and adhesive property.

Examples of the another thermoplastic resin include polyolefin-base resins such as high-density polyethylene (HDPE), low-density polyethylene (LDPE), ultrahigh molecular weight polyethylene (UHMWPE), isotactic polypropylene and ethylenepropylene copolymer (EPR); polyester-base resins such as aromatic polyesters, e.g., polybutylene terephthalate (PBT), polyethylene terephthalate (PET), polyethylene isophthalate (PEI), polyester copolymer, PET/PEI copolymer, polyarylate (PAR), polybutylene naphthalate (PBN), liquid crystal polyester, polyoxyalkylenediimidic acid/polybutyrate terephthalate copolymer; polyether-base resins such as polyacetal (POM), polyphenylene oxide (PPO), polyphenylene sulfide (PPS), polysulfone (PSF) and polyether ether ketone (PEEK); polynitrile-base resins such as polyacrylonitrile (PAN), polymethacrylonitrile, acrylonitrile/styrene copolymer (AS), methacrylonitrile/styrene copolymer, acrylonitrile/butadiene/styrene copolymer (ABS), methacrylonitrile/styrene/butadiene copolymer; polymethacrylate-base resins such as polymethyl methacrylate (PMMA) and polyethyl methacrylate; polyvinyl-base resins such as polyvinyl acetate (EVA), polyvinylidene chloride (PVDC), polyvinyl chloride (PVC), vinyl chloride/vinylidene chloride copolymer and vinylidene chloride/methyl acrylate copolymer; cellulose-base resins such as cellulose acetate and cellulose butyrate; fluororesins such as polyvinylidene fluoride (PVDF), polyvinyl fluoride (PVF), polychlorofluoroethylene (PCTFE) and tetrafluoroethylene/ethylene copolymer (ETFE); carbonate-base resins such as polycarbonate (PC); and imide-base resins such as aromatic polyimide (PI).

In the polyamide resin or composition for use in the joint material constituting the fuel pipe joint of the present invention, a reinforcement is preferably added.

Examples of the reinforcement include glass fiber, carbon fiber, fibrous inorganic materials such as wallastonite and potassium titanate whisker, organic fibers such as aramide fiber, and inorganic filler such as montmorillonite, talc, mica, calcium carbonate, silica, clay, kaolin, glass powder and glass bead.

The fibrous inorganic material has a fiber diameter of 0.01 to 20 μm, preferably from 0.03 to 15 μm, and a fiber cut length of 0.5 to 10 mm, preferably from 0.7 to 5 mm.

In particular, glass fiber is high in the reinforcing effect and can be suitably used. By the glass fiber reinforcement, the joint part can have high creep resistance and causes no deformation and eternal sealing can be attained.

The amount of the reinforcement used in the polyamide resin or composition is from 5 to 65 wt %, preferably from 10 to 60 wt %, more preferably from 10 to 50 wt %. If the amount used is less than 5 wt %, the mechanical strength of polyamide cannot be sufficiently enhanced, whereas if it exceeds 65 wt %, the moldability or surface appearance is disadvantageously worsened, though the mechanical strength is fully satisfied.

Also, in the polyamide resin or composition for use in the joint material of the present invention, an electrically conducting filler is preferably added. By joining an electrically conducting joint and an electrically conducting tube to form a current-conveying circuit, an electrostatic charge generated at the transportation of a fluid such as fuel can be dissipated and the parts can be prevented from damage or explosion due to sparking.

The electrically conducting filler as used in the present invention includes all fillers which can impart electrically conducting performance to resin and examples thereof include particulate, flaked or fibrous fillers.

Examples of the particulate filler which can be suitably used include carbon black and graphite. Examples of the flaked filler which can be suitably used include alumina flake, nickel flake and nickel-coated mica. Examples of the fibrous filler which can be suitably used include carbon fibers, carbon-coated ceramic fibers, carbon whiskers, carbon nanotubes and metal fibers such as aluminum fibers, copper fibers, brass fibers and stainless steel fibers. Among these, carbon black, carbon fibers and carbon nanotubes are preferred.

In the case of a fibrous filler, the filler preferably has an aspect ratio of 50 or more and a short axis of 0.5 nm to 10 μm.

The carbon black which can be used in the present invention includes all carbon blacks commonly used for imparting electrical conductivity. Preferred examples of the carbon black include, but are not limited to, acetylene black obtained by the incomplete combustion of acetylene gas, Ketjen black produced by the furnace-type incomplete combustion starting from a crude oil, oil black, naphthalene black, thermal black, lamp black, channel black, roll black and disk black. Among these, acetylene black and furnace black (Ketjen black) are more preferred.

As for the carbon black, various carbon powders differing in the properties such as particle size, surface area, DBP absorption and ash content are being produced. The carbon black which can be used in the present invention is not particularly limited in these properties, however, those having a good chained structure and a large aggregation density are preferred. In view of impact resistance, the carbon black is preferably not blended in a large amount. In order to obtain excellent electrical conductivity with a smaller amount, the average particle size of carbon black is preferably 500 nm or less, more preferably from 5 to 100 nm, still more preferably from 10 to 70 nm, the surface area (by BET method) is preferably 10 m²/g or more, more preferably 300 m²/g or more, still more preferably from 500 to 1,500 m²/g, and the DBP (dibutyl phthalate) absorption is preferably 50 ml/100 g or more, more preferably 100 ml/100 g or more, still more preferably 300 ml/100 g or more. The ash content of carbon black is preferably 0.5% or less, more preferably 0.3% or less. The DBP absorption as used herein means a value measured by the method prescribed in ASTM-D2414. A carbon black having a volatile content of less than 1.0 wt % is more preferred.

The electrically conducting filler may be surface-treated with a surface-treating agent such as titanate-type, aluminum-type or silane-type surface-treating agent. Pelletized particles may be used to improve melting and kneading workability.

The amount of the electrically conducting filler added varies depending on the kind of electrically conducting filler used and cannot be indiscriminately specified, however, in view of a balance in the electrical conductivity with melt-flowability, mechanical strength and the like, the electrically conducting filler in general is preferably added in an amount of 2 to 30 wt % in the polyamide resin or polyamide resin composition.

For the purpose of obtaining a sufficiently high antistatic performance, the electrically conducting filler is preferably blended in such an amount that the molded article obtained by melt-extruding a polyamide resin composition containing the electrically conducting filler has a volume resistance of 10⁹ Ω·cm or less, more preferably 10⁶ Ω·cm or less. However, the blending of the electrically conducting filler is liable to incur lowering of mechanical strength and melt flowability and, therefore, if the objective electrical conductivity level can be achieved, the amount of the electrically conducting filler blended is preferably reduced to as little as possible.

In the polyamide for use in the joint material constituting the fuel pipe joint of the present invention, the above-described reinforcement and electrically conducting filler are preferably blended at a weight ratio of 1:3 to 3:1.

Furthermore, in the polyamide for use in the joint material constituting the fuel pipe joint of the present invention, an antioxidant, a heat stabilizer, an ultraviolet absorbent, a light stabilizer, a lubricant, an inorganic fine particle, an antistatic agent, a flame retardant, a crystallization accelerator, a plasticizer, an impact improver and the like may be added, if desired.

The nylon 9T for use in the present invention can be produced by a polyamide polymerization method known as a method for producing a crystalline polyamide. The production apparatus may be a known polyamide production apparatus such as batch-system reactor, one-bath or multi-bath continuous reaction apparatus, tubular continuous reaction apparatus and kneading reaction extruder (e.g., single-screw extruder, twin-screw extruder). The nylon 9T can be produced by using a known polymerization method such as melt polymerization, solution polymerization and solid phase polymerization, and repeating the operation under atmospheric pressure, reduced pressure or elevated pressure. These polymerization methods can be used individually or in an appropriate combination.

For example, a terminal-blocking agent and a catalyst are added en bloc to the diamine component and dicarboxylic acid component to produce a nylon salt. Thereafter, a prepolymer having a intrinsic viscosity [η] of 0.1 to 0.6 dl/g at 30° C. in concentrated sulfuric acid is produced at a temperature of 280° C. or less and then further subjected to solid phase polymerization or polymerization using a melt-extruder, whereby the polyamide used in the present invention can be easily obtained. When the intrinsic viscosity [η] of the prepolymer is from 0.1 to 0.6 dl/g, unbalance between carboxyl group and amino group and reduction in the polymerization rate can be suppressed at the later polymerization stage and a polyamide having smaller molecular weight distribution, excellent performances and improved moldability can be obtained. In the case where the final stage of polymerization is performed by the solid phase polymerization, this is preferably performed under reduced pressure or in an inert gas stream and the polymerization temperature is preferably from 180° C. to the temperature below the melting point of polyamide resin obtained by 10° C., because the polymerization proceeds at a high rate to give good productivity and the coloration or gelling can be effectively suppressed. In the case where the final stage of polymerization is performed by using a melt-extruder, the polymerization temperature is preferably 370° C. or less, because the polyamide scarcely decomposes and a polyamide free of deterioration can be obtained.

Examples of the catalyst include phosphoric acid, phosphorous acid, hypophosphorous acid, and salts and esters thereof, specifically, metal salts such as potassium, sodium, magnesium, vanadium, calcium, zinc, cobalt, manganese, tin, tungsten, germanium, titanium and antimony, ammonium salt, ethyl ester, isopropyl ester, butyl ester, hexyl ester, isodecyl ester, octadecyl ester, decyl ester, stearyl ester and phenyl ester.

Specific examples of the fuel pipe joint of the present invention includes a fuel pipe quick connector where the cylindrical body part is formed of the above-described joint material.

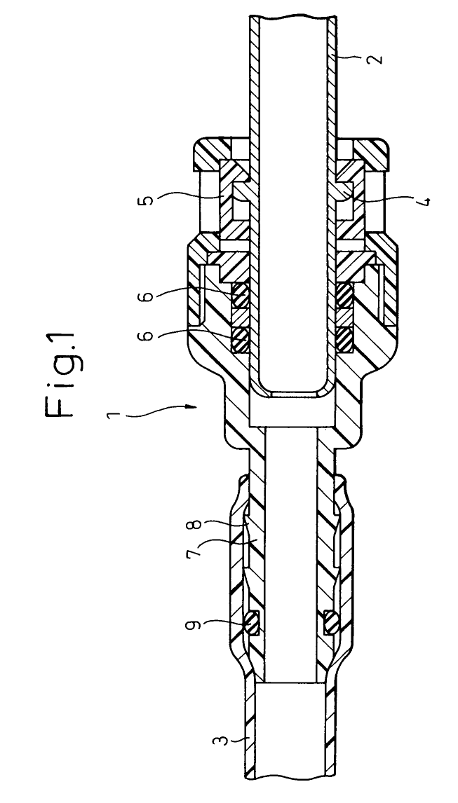

FIG. 1 shows a cross-sectional view of a representative quick connector 1. In the quick connector 1 shown, the end part of a steel tube 2 and the end part of a plastic tube 3 are connected with each other. The connector is removably engaged by a flange-shaped part 4 provided apart from the end part of the steel tube 2 and a retainer 5 of the connector 1 and the fuel is sealed in by an O-ring bank 6. The retainer 5 is preferably formed of the above-described joint material. At the joint part of the plastic tube 3 and the connector 1, a long nipple 7 having a plurality of radially protruded barbs 8 forms the connector end part. The end part of the plastic tube 3 is contact-fitted with the outer surface of the nipple 7 and the fuel is sealed in by the mechanical joining with barbs 8 and an O-ring 9 provided between the tube and the nipple.

Examples of the method for producing a quick connector include a method of preparing respective parts such as cylindrical body, retainer and O-ring by injection molding and then assembling these parts to predetermined places.

The quick connector is assembled in the form engaged with a resin tube and used as a fuel pipe component.

The quick connector and the resin tube may be mechanically joined by fitting but are preferably joined by welding such as spin welding, vibration welding, laser welding or ultrasonic welding, because the airtightness or liquidtightness can be enhanced.

After the insertion, the overlapped part may be sufficiently clamped by using a thick-wall resin tube, heat-shrinking tube, clip or the like to enhance the airtightness.

The resin tube may have an undulated region in the middle. The undulated region means a region resulting from forming an appropriate region in the middle of a tube body to have a shape of wave, bellows, accordion, corrugation or the like. By having such a region that a plurality of folds of undulation are annularly provided, one side of the annularity in that region can be compressed and another side can be extended outward, so that the tube can be easily bent at an arbitrary angle without accompanying stress fatigue or separation between layers.

The resin tube preferably takes a multilayer structure containing a barrier layer in addition to the polyamide layer such as nylon 11 and nylon 12. For example, PBT, PBN, fluororesin, nylon 9T, nylon containing nano-dispersed clay, and EVOH (ethylene-vinyl alcohol copolymer) can be used as the resin for forming the barrier layer.

When used in the line where a liquid fuel flows, the resin tube preferably have a constitution including an electrically conducting layer in the innermost layer in order to prevent the damage by electrostatic charge.

By taking account of pebbling, abrasion with other parts and flame resistance, a solid or sponge-like protective member (protector) formed of epichlorohydrin rubber, nitril-butadiene rubber (NBR), a mixture of NBR and polyvinyl chloride, chlorosulfonated polyethylene rubber, chlorinated polyethylene rubber, acrylic rubber (ACM), chloroprene rubber (CR), ethylene-propylene rubber (EPR), ethylene-propylene-diene rubber (EPDM), a mixture rubber of NBR and EPDM, or a thermoplastic elastomer such as vinyl chloride type, olefin type, ester type and amide type, may be provided on the entire surface or on a part of the outer periphery of the resin tube. The protective member may be formed as a sponge-like porous body by a known method. By forming it as a porous body, a lightweight and highly adiabatic protective part can be provided. Also, the material cost can be reduced. Alternately, the mechanical strength may be improved by adding glass fiber or the like. The shape of the protective member is not particularly limited but a cylindrical member or a block member having a recess for receiving the multilayer tube is usually used. In the case of a cylindrical member, a multilayer tube is inserted into a previously prepared cylindrical member or a cylindrical member is coated by extrusion on a multilayer tube, so that the cylindrical member and the multilayer tube can be tightly contacted. For bonding the protective member and the multilayer tube, an adhesive is coated, if desired, on the inner surface or recess surface of the protective member and a multilayer tube is inserted or fitted thereinto to make them tightly contact with each other, thereby forming a structure where a multilayer tube and a protective member are integrated.

By using enhancing technique of improving seal performance such as an O-ring or welding in combination, the fuel pipe quick connector of the present invention can be reduced in the amount of fuel gasoline-mixed fuel or the like permeating through the wall and favored with excellent properties such as creep deformation resistance. Therefore, when combined with a multilayer tube having excellent barrier property, this is useful as an excellent fuel line system capable of flexibly coping with the strict regulations regarding the emission of fuel.

The fuel pipe joint of the present invention can greatly prevent the permeation of fuel through wall. Furthermore, a pipe system having high sealing property can be established by the weld-joining with a polyamide tube. Therefore, the fuel pipe joint can be suitably used particularly for the fuel pipe quick-connector used in automobiles.

### EXAMPLES

The present invention is described in greater detail below by referring to Examples and Comparative Examples, however, the present invention is not limited thereto.

In Examples and Comparative Examples, the analysis and measurement of physical properties were performed as follows.

[Relative Viscosity]

The relative viscosity was measured according to JIS K6810 in 98% sulfuric acid under the conditions that the polyamide concentration was 1% and the temperature was 25° C.

[Intrinsic Viscosity]

The inherent viscosity (ηᵢₙₕ) of samples having a concentration of 0.05, 0.1, 0.2 or 0.4 g/dl was measured in concentrated sulfuric acid and a value obtained by extrapolating the measured value to the concentration 0 was used as an intrinsic viscosity [η].

ηᵢₙₕ=[ln(t₁/tₒ)]/c

[wherein ηᵢₙₕ represents an inherent viscosity (dl/g), tₒ represents a flow-down time (sec) of solvent, t₁ represents a flow-down time (sec) of sample solution, and c represents a concentration (g/dl) of sample in solution].

[Evaluation of Physical Properties]

(Mechanical Properties)

The following properties were evaluated according to ASTM.

Bending modulus: ASTMD-790

Izod notched impact strength: ASTMD-256

Electric resistance: ASTMD-257

(Fuel Permeability)

A joint having an outer diameter of 8 mm, a wall thickness of 2 mm and a length of 100 mm was prepared, one end thereof was plugged, ethanol/gasoline obtained by mixing Fuel C (isooctane/toluene=50/50 by volume) and ethanol at a volume ratio of 90/10 was charged into the inside, and the other end was also plugged. Thereafter, the entire weight was measured, then the joint was placed in an oven at 60° C., the change in weight was measured and the fuel permeability (the amount of fuel permeated and the amount of hydrocarbon contained therein (HC amount) both are shown) was evaluated.

### Materials Used in Examples and Comparative Examples

(A) Nylon 9T

(A-1) Production of Nylon 9T

An autoclave was changed with, 32,827 g (197.6 mol) of terephthalic acid, 25,326 g (160 mol) of 1,9-nonanediamine, 6,331.6 g (40 mol) of 2-methyl-1,8-octanediamine, 586.2 g (4.8 mol) of benzoic acid, 65 g of sodium hypophosphite monohydrate (0.1 wt % based on raw material) and 40 liters of distilled water, and the atmosphere of the autoclave was replaced by nitrogen.

The contents were stirred at 100° C. for 30 minutes and the internal temperature was elevated to 210° C. over 2 hours. At this time, the pressure within the autoclave was elevated to 22 kg/cm². In this state, the reaction was continued for 1 hour and then the temperature was elevated to 230° C. Thereafter, the temperature was kept at 230° C. for 2 hours and the reaction was performed while keeping the pressure at 22 kg/cm² by gradually extracting the water vapor. Subsequently, the pressure was decreased to 10 kg/cm² over 30 minutes and the reaction was further performed for 1 hour to obtain a prepolymer having an intrinsic viscosity [η] of 0.25 dl/g. This prepolymer was dried at 100° C. under reduced pressure, ground to a size of 2 mm or less and then subjected to solid phase polymerization at 230° C. and 0.1 mmHg for 10 hours to obtain nylon 9T having a melting point of 301° C. and an intrinsic viscosity [η] of 1.21 dl/g (hereinafter this nylon resin is referred to as (A-1)).

(A-2) Production of Nylon 9T

Nylon 9T having a melting point of 293° C. and an intrinsic viscosity [η] of 1.23 dl/g was obtained in the same manner as in (A-1) Production of Nylon 9T except that in (A-1) Production of Nylon 9T, 25,326 g (160 mol) of 1,9-nonanediamine was changed to 22,161 g (140 mol) and 6,331.6 g (40 mol) of 2-methyl-1,8-octanediamine was changed to 9,497.4 g (60 mol) (hereinafter this nylon resin is referred to as (A-2)).

(A-3) Nylon 9T-GF30

In A-1, 30 wt % of glass fiber (CS-3J-265S produced by Nitto Boseki Co., Ltd.) was kneaded therein.

(A-4) Nylon 9T-GF15/CF15

In A-1, 15 wt % of glass fiber (CS-3J-265S produced by Nitto Boseki Co., Ltd.) and 15 wt % of carbon fiber (K223SE produced by Mitsubishi Chemical Corporation) were kneaded therein.

(B) Nylon 12 Resin

(B-1) UBESTA3030U produced by Ube Industries, Ltd. (relative viscosity: 2.85)

(B-2) UBESTA3024GC6 produced by Ube Industries, Ltd. (relative viscosity: 2.45, containing 30 wt % of glass fiber)

(B-3) UBESTA3030JFX1 produced by Ube Industries, Ltd. (relative viscosity: 2.85, containing a plasticizer)

(C) Nylon 66 Resin

(C-1) UBESTA2020B produced by Ube Industries, Ltd. (relative viscosity: 2.96)

### Example 1

A test piece according to the ASTM standard was molded by using nylon 9T (A-1) and measured on the mechanical properties. Also, a joint was molded by using nylon 9T (A-1) and measured on the fuel permeability. The results are shown in Table 1.

As seen from Table 1, the rigidity necessary for the connector is superior to nylon 12 and this resin is physically suitable for a joint. Furthermore, from the fuel permeability test, the joint is revealed to have excellent barrier property against fuel, particularly against a harmful hydrocarbon component.

### Example 2

A test piece according to the ASTM standard was molded by using nylon 9T (A-2) and measured on the mechanical properties. Also, a joint was molded by using nylon 9T (A-2) and measured on the fuel permeability. The results are shown in Table 1.

As seen from Table 1, the rigidity necessary for the connector is superior to nylon 12 and this resin is physically suitable for a joint. Furthermore, from the fuel permeability test, the joint is revealed to have excellent barrier property against fuel, particularly against a harmful hydrocarbon component.

### Example 3

A test piece according to the ASTM standard was molded by using nylon 9T (A-3) and measured on the mechanical properties. Also, a joint was molded by using nylon 9T (A-3) and measured on the fuel permeability. The results are shown in Table 1.

As seen from Table 1, the rigidity necessary for the connector is superior to nylon 12 and this resin is physically suitable for a joint. Furthermore, from the fuel permeability test, the joint is revealed to have excellent barrier property against fuel, particularly against a harmful hydrocarbon component.

### Example 4

A test piece according to the ASTM standard was molded by using nylon 9T (A-4) and measured on the mechanical properties. Also, a joint was molded by using nylon 9T (A-4) and measured on the fuel permeability. The results are shown in Table 1.

As seen from Table 1, the rigidity necessary for the connector is superior to nylon 12 and this resin is physically suitable for a joint. Furthermore, from the fuel permeability test, the joint is revealed to have excellent barrier property against fuel, particularly against harmful hydrocarbon component.

In addition, the electric resistance was 10⁶ Ω or less and this joint, having excellent electrostatic charge removing performance, can be suitably used particularly for a liquid fuel line.

### Comparative Example 1

A test piece according to the ASTM standard was molded by using nylon 12 (B-1) and measured on the mechanical properties. Also, a joint was molded by using nylon 12 (B-1) and measured on the fuel permeability. The results are shown in Table 1.

### Comparative Example 2

A test piece according to the ASTM standard was molded by using nylon 12 (B-2) and measured on the mechanical properties. Also, a joint was molded by using nylon 12 (B-2) and measured on the fuel permeability. The results are shown in Table 1.

### Comparative Example 3

A test piece according to the ASTM standard was molded by using nylon 66 (C-1) and measured on the mechanical properties. Also, a joint was molded by using nylon 66 (C-1) and measured on the fuel permeability. The results are shown in Table 1.

Welding of Nylon 9T Joint to Nylon 12 Tube:

### Welding Example 1

A joint having an outer diameter of 8 mm, a wall thickness of 2 mm and a length of 100 mm was molded by using nylon 9T (A-1) and for the press-fitting into a tube, the region from 5 mm behind the distal end toward the distal end was coned by cutting to reduce the outer diameter from 8 mm to 7 mm.

Separately, a tube having an inner diameter of 7.5 mm and an outer diameter of 10 mm was obtained by using nylon 12 (B-1).

The obtained joint was press-fitted to a length of 20 mm into the tube and joined by spin welding.

When the joint and tube joined were pulled away, the bonded state was maintained even in the state where the tube was 50% elongated. Thus, strong adhesion was exhibited and this reveals that joining with excellent air-tightness or liquid-tightness can be attained.

### Welding Example 2

A joint having an outer diameter of 8 mm, a wall thickness of 2 mm and a length of 100 mm was molded by using nylon 9T (A-1) and for the press-fitting into a tube, the region from 5 mm behind the distal end toward the distal end was coned by cutting to reduce the outer diameter from 8 mm to 7 mm,

Separately, a tube having an inner diameter of 7.5 mm and an outer diameter of 10 mm was obtained by using nylon 12 (B-3).

After the obtained joint was preheated in an oven at 150° C. for 30 seconds, the joint was press-fitted to a length of 20 mm into the tube and joined by spin welding.

When the joint and tube were pulled away, the bonded state was maintained even in the state where the tube was 50% elongated. Thus, strong adhesion was exhibited and this reveals that joining with excellent air-tightness or liquid-tightness can be attained.

### Welding Comparative Example 1

A spin-welded product was prepared in the same manner as in Welding Example, except for molding the joint by using nylon 66 (C-1).

When the joint and tube joined were pulled away, separation occurred at the joined part before the tube was 50% elongated. Thus, weak adhesive strength was exhibited and this reveals that air-tightness or liquid-tightness cannot be ensured.

TABLE 1

| | Resin | | | Flexural | | Amount of Fuel | |
|---|---|---|---|---|---|---|---|
| | | Reinforcement | Flexural | Modulus, | Impact | Permeated/ | Electric |
| | | (amount | Modulus | (Wet 23%, RH 65%) | Strength, | Amount of HC | Resistance |
| | Kind | blended) | (Dry) MPa | MPa | J/m | (mg/day) | Ω |
| Example 1 | nylon 9T | | 2600 | 2500 | 50 | 1.8/0.1 | 10¹⁵ |
| | A-1 | | | | | | |
| Example 2 | nylon 9T | | 2500 | 2400 | 48 | 2.0/0.2 | 10¹⁵ |
| | A-2 | | | | | | |
| Example 3 | nylon 9T | GF (30%) | 8300 | 8200 | 100 | 2.4/0.3 | 10¹⁵ |
| | A-3 | | | | | | |
| Example 4 | nylon 9T | GF (15%) | 10500 | 10000 | 123 | 2.3/0.3 | 10⁶ |
| | A-4 | CF (15%) | | | | | |
| Comparative | nylon 12 | | 1500 | 1100 | 70 | 51.1/31.6 | 10¹⁵ |
| Example 1 | B-1 | | | | | | |
| Comparative | nylon 12 | GF (30%) | 5600 | 4600 | 200 | 56.5/33.2 | 10¹⁵ |
| Example 2 | B-2 | | | | | | |
| Comparative | nylon 66 | | 2700 | 1400 | 50 | 38.2/4.2 | 10¹⁵ |
| Example 3 | C-1 | | | | | | |

Gh: glass fiber,
CF: carbon fiber.
The amount blended indicates wt % based on the entire composition.

1. A fuel pipe joint having excellent fuel permeation resistance, using a joint material comprising a polyamide (nylon 9T) consisting of a dicarboxylic acid component and a diamine component, with 60 to 100 mol % of the dicarboxylic acid component being terephthalic acid and 60 to 100 mol % of the diamine component being a diamine component selected from 1,9-nonanediamine and 2-methyl-1,8-octanediamine.

2. A fuel pipe joint having excellent fuel permeation resistance, using a joint material comprising a polyamide resin composition comprising from 50 to 99 parts by weight of a polyamide (nylon 9T) and from 1 to 50 parts by weight of another polyamide resin and/or another thermoplastic resin, said polyamide (nylon 9T) consisting of a dicarboxylic acid component and a diamine component, with 60 to 100 mol % of the dicarboxylic acid component being terephthalic acid and 60 to 100 mol % of the diamine component being a diamine component selected from 1,9-nonanediamine and 2-methyl-1,8-octanediamine.

3. The fuel pipe joint as claimed in claim 1 or 2, wherein the joint material further comprises a reinforcement.

4. The fuel pipe joint as claimed in claim 1 or 2, wherein the joint material further comprises an electrically conducting filler.

5. The fuel pipe joint as claimed in claim 4, wherein the electrically conducting filler has an aspect ratio of 50 or more and a short diameter of 0.5 nm to 10 μm.

6. The fuel pipe joint as claimed in claim 1 or 2, wherein the joint material further comprises a reinforcement and an electrically conducting filler at a ratio of 1:3 to 3:1 by weight.

7. A fuel pipe quick connector comprising a cylindrical body formed of the joint material claimed in claim 1 or 2.

8. The fuel pipe quick connector comprising a cylindrical body formed of the joint material as claimed in claim 3.

9. The fuel pipe quick connector comprising a cylindrical body formed of the joint material as claimed in claim 4.

10. The fuel pipe quick connector comprising a cylindrical body formed of the joint material as claimed in claim 5.

11. The fuel pipe quick connector comprising a cylindrical body formed of the joint material as claimed in claim 6.

12. The fuel pipe quick connector as claimed in claim 7, comprising a joint body having first and second end portions, from said first to second end portions of the joint body a continuous hollow portion being formed, said first end portion of said joint body being able to sealingly engage with a resin first tube, said second end portion of said joint body being able to liquid-tightly engage with a male-type second tube, wherein said joint body is made of said joint material.

13. The fuel pipe quick connector as claimed in claim 12, wherein said first end portion of said joint body is formed as a nipple.

14. The fuel pipe quick connector as claimed in claim 13, further comprising an O-ring around said nipple of said first end portion of said joint body for liquid-tightly connecting said resin first tube.

15. The fuel pipe quick connector as claimed in claim 14, wherein said nipple of said first end portion of said joint body has a plurality of protruded barbs on an outer peripheral surface thereof.

16. The fuel pipe quick connector as claimed in claim 12, further comprising an O-ring around said hollow portion at said second end portion of said joint body in order to liquid-tightly engage with said male-type second tube.

17. The fuel pipe quick connector as claimed in claim 12, wherein said second tube is a stainless steel or resin tube.

18. The fuel pipe quick connector as claimed in claim 12, wherein said second tube has a flange portion and said fuel pipe quick connector further comprises a retainer inside said fuel joint body at said second end portion thereof for engaging with and retaining the flange portion of said second tube.

19. The fuel pipe quick connector as claimed in claim 18, wherein said retainer is made of said joint material.

20. A fuel pipe component obtained by joining the quick connector claimed in claim 7 with a polyamide resin tube by a welding method selected from spin welding, vibration welding, laser welding and ultrasonic welding.

21. The fuel pipe component as claimed in claim 20, wherein the polyamide resin tube is a multilayer tube comprising a barrier layer.
